(19) United States
(12) Patent Application Publication
(10) Pub. No.: US 2003/0163808 A1
(43) Pub. Date: Aug. 28, 2003

(54) Electronic delivery of software access to an end-user

(76) Inventor: Kristi Cordova, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/085,442

(22) Filed: Feb. 28, 2002

(51) Int. Cl. G06F 17/30

(52) U.S. Cl. 717/176; 707/9

(57) ABSTRACT

In one embodiment, the present invention is directed to a method of unlocking electronic files stored in a master database. The method may comprise the steps of: accepting from a user a purchase request for a license and a key to unlock specific stored software; processing accepted requests, including obtaining an electronic delivery address for the user and verifying the availability to the user of the requested key; and electronically delivering to the requesting user one or more keys for unlocking the specific electronic file.

### BACKGROUND OF THE INVENTION

For most PC products, a supplier of a software product would copy the software onto a disk or other medium, place the medium in a package, shrink wrap the package, and place the shrink wrapped software in a shipping box together with use instructions and, most importantly from the supplier's prospective, a license. These licenses then became known as shrink wrap licenses, because the user would be warned not to open the shrink wrapped software until the user read and agreed to the terms of the license.

For many enterprise users, particularly users of Unix Software Products, several software packages, or applications, are provided on a single CD (or other medium), each application requiring a separate license for the use of that application. This makes the distribution and management of the software easier, particularly for enterprise customers, where long term relationships exist between the supplier and the user. But in these situations, the problem remains as to how to deliver the software faster to the end-user when the end-user decides to use a particular application already in its possession on a CD (or other medium).

This has led to initiatives to deliver software (and associated licenses) directly from the supplier (or from an intermediary) over a communication link between the user and the supplier. This link often has been the Internet. Such a system has provided customers with faster access to software and/or licenses and has reduced costs for the supplier (vendor).

It is not uncommon for an end-user to decide that he/she requires a specific software application to perform a task and also desires to have that software available immediately so that the task can be performed without delay. In an effort to achieve quick response time for this type of situation, a supplier may deliver several applications to a potential end-user at one time. For example, a supplier may copy several software applications onto one or more media such as a CD or DVD, in a manner such that the end-user can not actually use any of the applications without a password (code) which is attached to the license and which unlocks each specific application for a particular user. This access code is then given to an end-user in return for payment for the software license by the end-user. If the desired application is covered by a license that has already been agreed to, there is no need for a new license. However, in some situations the newly desired application which is contained on a previously purchased storage medium is not covered by a license which requires that a license be purchased by the user in order to gain access to the software via a code word.

In the current operation, when a plurality of software applications have been pre-delivered to an end-user but has been coded such that the end-user can not access individual applications without obtaining the code, the end-user must contact the supplier and purchase the license in order to request the unlocking code. The end-user and the supplier agree upon payment terms and, if necessary, license terms, and the supplier prints the code, perhaps in conjunction with a license which must be agreed to by the end-user, and packages the printed code, and any other paper required, and mails it to the end-user. This process is time consuming, costly, and does not meet the needs of the end-user who desires to use the software application as soon as possible, but can not do so until the code arrives from the supplier, usually more than a week after the initial contact.

In one known application, a user logs onto a URL site and downloads onto a computer a software application for test purposes. The “test” consists of the user running some portion of the application in a limited fashion. If the user then later desires to “purchase” the application, the user arranges for payment to the owner and then receives from the owner a key to unlock the remainder of the “test” program.

### BRIEF SUMMARY OF THE INVENTION

In one embodiment, the present invention is directed to a method of unlocking electronic files stored in a master database. The method may comprise the steps of: accepting from a user a purchase request for a license and a key to unlock specific stored software; processing accepted requests, including obtaining an electronic delivery address for the user and verifying the availability to the user of the requested key; and electronically delivering to the requesting user one or more keys for unlocking the specific electronic file. The system is operative to avoid sending the license or code-word in paper format.

### BRIEF DESCRIPTION OF THE DRAWINGS

FIG. 1 shows a block diagram of one embodiment of the invention;

FIG. 2 shows a flow chart of the various operations of one embodiment of the invention; and

FIG. 3 shows a flow chart pertaining to obtaining and using an unlocking code by a user.

### DETAILED DESCRIPTION OF THE INVENTION

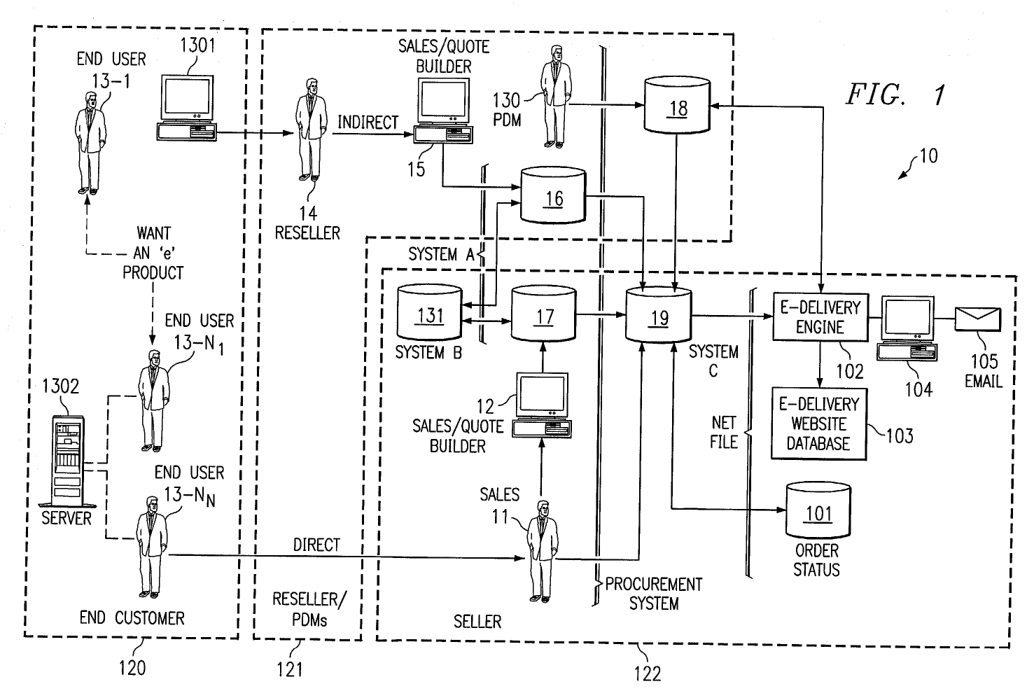

Turning now to FIG. 1, system 10 is shown. For the purpose of discussion, system 10 is divided into three sections which are: end customer section 120; reseller (distributor) section 121; and supplier section 122. The end-user in the example has received a plurality of individual software applications (not shown) via a CD-ROM or other medium (perhaps containing 200 or more software applications), one or more of which can not be accessed by the user without paying for a license for the right to use and obtaining a password (code) to unlock the desired application(s). In some instances, the software will reside on a server, such as server 1302, at the end-user's location and available to many users sharing a community of interest. The software could be stored at a site remote from the user, but accessible only to a user having the right code. Sometimes additional codes will be necessary to allow different users access to a particular application. These codes are obtained from the supplier after purchase of the right-to-use license and can be unique to the end-user as the supplier desires. End-users 13-1 through 13-N access the system to obtain access codes to allow them to use software applications after paying for the license and receiving a unique URL. When accessed by the end-user at a site dictated by an address, such as a URL address, the accessed site provides the end-user a code for unlocking the software which software, as discussed above, the end-user already has, but which has been blocked from use. Note that, as will be discussed, this system works for customers ordering through the channel or ordering direct.

In one embodiment, each order placed by a user will result in a unique URL being generated for that user. In the situation where the desired software resides on a server, such as server 1302, available to a number of potential users, the system keeps track of how many users can access the software and only allows for that number of unlocking codes. The unlocking codes for the number of authorized users, for example two, can be obtained at the same URL and could, if desired, be keyed to a machine used by the user, or could be keyed to a number of processors available within the server. Thus, if desired, a specific processor within a server, can be assigned a unique URL by the system where a user could obtain the necessary unlock codes.

Assuming a reseller is in the supply chain, the end-user would contact the reseller, for example reseller 14, to place an order (usually by telephone) or, if desired, electronically via computer 1301. This order could be placed with a live operator or by a machine and would contain a particular product number. If that product has an electronic delivery option an e-mail address of the user would be captured and an order would be placed on tool 15, called Sales/Quote Builder. Tool 15 provides coordination between the reseller and the supplier ordering system by providing quotes which may be different for each customer based on negotiated contracts. When tool 15 recognizes that the desired product can be delivered electronically, the tool requires the reseller to input the end-user's proper e-mail address. This email address from the user could already be stored in a database and in which case the address is received.

Once the desired information is obtained from the user, the price is set by tool 15 working in conjunction with system A tool 16. Tool 16 contains configuration capability and factory availability information. The pricing information for the particular end-user is provided to the reseller who then passes it on to the end-user. In one embodiment, the supplier price list is stored in system B 131, which operates in conjunction with tool 16.

The “order” for the software then goes to tool 19, system C. System C receives orders and routes them to the proper place in the factory to facilitate delivery of an ordered product. When an actual product is to be shipped, tool 19 actually delivers the product to the factory floor. However, since in our example, the product (license and code) is to be delivered electronically based on the option by the end-user, tool 19 is modified to create an electronic license and to request the proper code from a control system, such as, server 18. Server 18 creates licenses and unique code words based, at least in part, on the sales order information, production information and a unique customer identifier, which could include a user processor ID, or machine ID.

For a particular order, server 18 takes a sales order number, plus the product number and creates a unique code word specific to that order. This code, pulls the proper license from eDelivery engine 102 which then sends e-mail 105 to the requesting end-user via terminal 104 thereby providing the end-user a URL (or other address information) which allows the end-user to then download the particular license and the unique code pertaining to the software application desired from a site accessed by the URL. Engine 102 will also place a copy of the electronic license in eDelivery website database 103 for storage and later retrieval. When the requesting end-user goes to the designated URL, the end-user, for security purposes, enters his/her order number, or any other code provided by the supplier, to obtain the passcode to the software.

The end-user knows that contained in the e-mail is a unique URL where the customer can go to pull down what he/she has ordered for that particular product. In addition, a customer can also do a search using that URL to see what that customer has purchased over a period of time, for example the past six months or so. This access is by sales order number, product number or by e-mail address, as desired. Using the URL, the end-user accesses a database, such as database 103 via gateway 104. As discussed above, the URL is unique to each order from an end-user. However, when several users share a server then the URL can be shared by the number of authorized users (which can be different for each application) or the URL can be unique for each user.

Thus, if a customer misplaces a code for a particular software product, (or in multiple user applications where the code may be available to a number of different users) the user (or users) could at any time access the URL to retrieve the code as desired. Access could be controlled by any one of a number of different techniques, including password protection, purchase order number, presence on a list of authorized users, processor or machine ID, etc.

Continuing in FIG. 1, the end-user, for example end-user 13-N, (which typically would be a large account) could order software directly from the supplier. In this situation, end-user 13-N would contact the supplier's direct sales force 11. The salesperson or administrator (or an electronic equivalent) would place the order in Sales/Quote Builder 12 which would function the same as Sales/Quote Builder 15, but typically would not be detached from its database as would be system 15. Sales/Quote Builder 12 works in conjunction with system A, tool 17 to establish the quote that is to be presented to end-user 13-N. In one embodiment, the supplier price list is stored in system B 131 which operates in conjunction with tool 17. Once a payment method is agreed upon with end-user 13-N and electronic delivery requested, the pertinent information is provided to system C, tool 19 and the system operates as discussed above. Note that the license is delivered directly via e-mail to the requesting user and the user, by accessing the identified URL, as discussed above can obtain the software unlocking code. Also, in either situation, the user could be given instructions as to how to access a code generation (via the URL or phone call) so the code could be established on a real-time interactive basis using the internet or other electronic connection. The code is generated as discussed above.

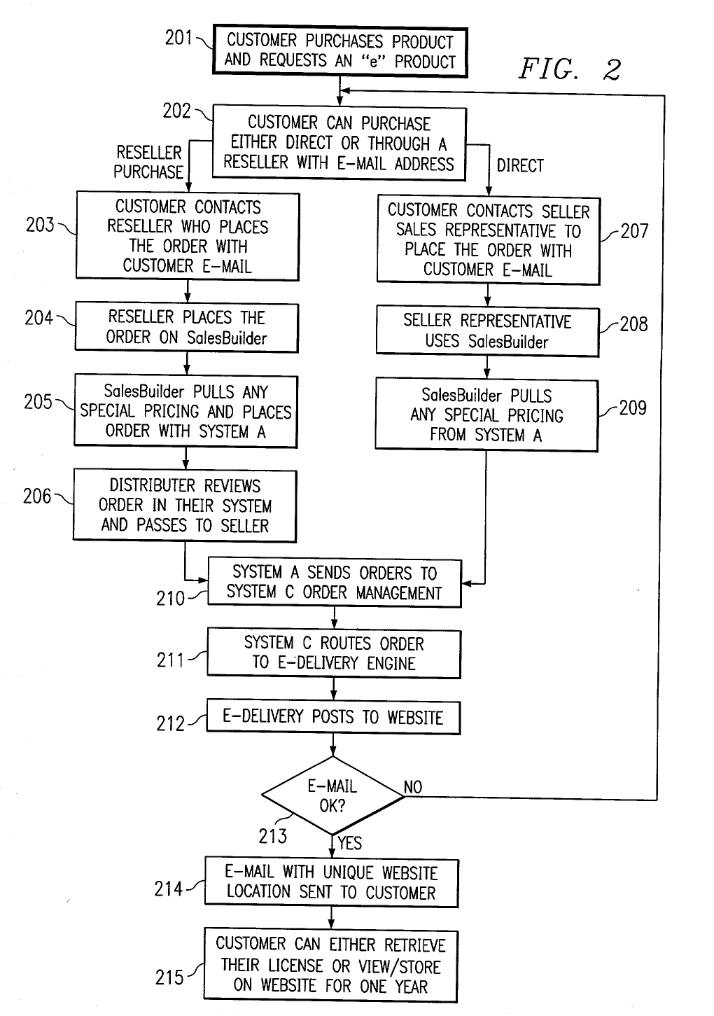

FIG. 2 shows the operational method of this system in which it is assumed that the customer (end-user) has in his/her possession a number of software programs, one or more of which have been locked so the user can only use the locked programs when a code is delivered to one user specific to the desired application. For example, as discussed above, there may be a DVD, CD or electronic connection, which has delivered several software applications to the customer, each application would require a separate code to allow that application to be utilized by the customer. In some situations, there may be one customer and in other situations there may be a plurality of customers that would access the system. A single code could be utilized for all of the customers or each user of a single enterprise could have a different code. Also, a single code could unlock multiple programs. Also note that, as discussed above, one URL could be used for each code, or multiple users could use the same URL if desired for the same order.

Step 201 shows a customer getting ready to request an “e” product which is available to the user but locked until a license is purchased which makes an unlocking code available. At step 202, the end-user begins the process of ordering the “code”, either through a reseller or direct from the supplier.

The path which includes steps 203, 204, 205, 206, is the path taken when a reseller is involved and the path which includes steps 207, 208, 209, is used when a direct contact is made from the end-user to the supplier. The main difference between the two paths is the reseller or distributor in step 206 reviews the orders before they are passed to the supplier. Of course, this is an optional step but one that would typically be performed by a distributor.

Steps 210, 211, 212, 213, 214 and 215 are self explanatory and perform as discussed above.

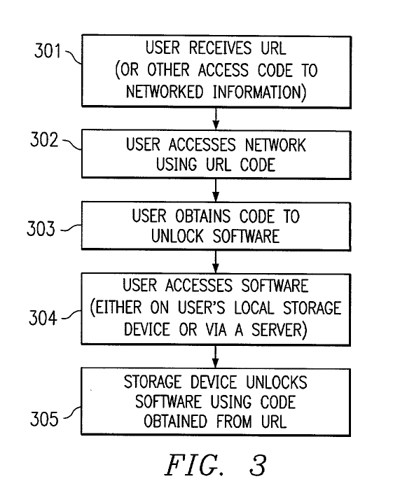

Turning now to FIG. 3, as discussed above, box 301 shows the user receiving a URL (or other address location on a public, or private network), and boxes 302 to 305 show the flow by the requesting user in order to obtain and ultimately use the unlocking code for a requested software application that is already in the user's presence.

Note that while we have discussed software applications, it should be understood that any electronic file could be unlocked in this manner. Thus, online training courses, help files, movies, documents, music and the like could be delivered to a user and then subsequently “unlocked” by the delivery of a key or code.

1. A method of delivering an electronic license and unlocking electronic files for the purpose of using software stored under the control of a user, said method comprising the steps of:
accepting from a user a request for a key to unlock specific ones of said stored code;
processing accepted ones of said requests; said processing including obtaining an electronic delivery address for said user and verifying the availability to said user of said requested key; and
electronically delivering to said requesting user the address of at least one network access destination, such that said requesting user can electronically access said destination to obtain from said destination a code for unlocking said specific electronic file.

2. The method of claim 1 wherein said accepting step can be accomplished by several different parties.

3. The method of claim 1 wherein said processing step can be accomplished by several different parties.

4. The method of claim 1 wherein said delivered code is also unique to a particular user and wherein said destination is a specific URL, said URL delivered to said user by said electronically delivering step.

5. The method of claim 1 wherein said delivered code is unique to one or more particular machines on which said electronic files may reside.

6. The method of claim 1 wherein said delivered code is unique to a particular storage medium.

7. The method of claim 1 wherein said delivered code is unique to a particular storage location.

8. A system for allowing a user to access an electronic file stored at said user's location, said system comprising:
an ordering system for interacting electronically with a user, said ordering system arranged to provide pricing information to said interacting user; said ordering system further arranged to receive from said electronically interacting user an electronic address of said interacting user;
an order delivery system interacting electronically with said ordering system; said delivery system arranged to deliver products ordered by said end-user; and further arranged to substitute electronic information in place of the actual product ordered, said electronic information operable for allowing said end-user to enable selected portions of said stored electronic file; and
a delivery engine for controlling the electronic delivery of said electronic information to said user, in accordance with received ones of said electronic addresses.

9. The system of claim 8 wherein said order delivery system is arranged to deliver actual products as well as said electronic information dependant in part upon interactions between said user and said ordering system.

10. The system of claim 8 wherein said electronic file is a plurality of files.

11. The system of claim 10 wherein said electronic information is specific to particular ones of said plurality of files.

12. The system of claim 8 wherein said electronic information is a web address which allows a user to access said address to obtain a key for unlocking at least a portion of said stored electronic files.

13. A method of delivering software, said method comprising the steps of:
delivering a plurality of different software applications to an end-user for storage on a server shared by a plurality of said users;
locking at least some of said loaded applications such that each said locked application can only be successfully utilized by a requesting one of said end-users under control of a code delivered to said requesting end-user by a third party; and
electronically delivering said code to a requesting end-user.

14. The method of claim 13 wherein said electronically delivering step can be accomplished based on a request from said requesting end-user, said request being initially directed to one of several different parties.

15. The method of claim 13 wherein said electronically delivering step can be accomplished from several different parties with respect to different applications.

16. The method of claim 13 wherein said electronically delivering step can be accomplished from several different parties with respect to the same applications.

17. The method of claim 13 wherein said electronically delivering step includes the step of electronically communicating a unique address accessible to said end-user, said unique address containing codes specific to one or more of said applications.

18. The method of claim 13 wherein said code is unique to a particular end-user.

19. The method of claim 13 wherein said code is unique to one or more particular machines on which said applications may reside.

20. The method of claim 13 wherein said code is unique to a particular storage medium and obtained by said end-user by said user electronically accessing a remote location, the location of said remote location communicated to said end-user as part of said electronically delivering step.
